(19) United States
(12) Patent Application Publication
(10) Pub. No.: US 2018/0373047 A1
(43) Pub. Date: Dec. 27, 2018

(54) OPTICAL MODULAR SYSTEM FOR COLLIMATED TOP-HAT DISTRIBUTION

(71) Applicant: asphericon GmbH, Jena (DE)

(72) Inventors: Ulrike FUCHS, Jena (DE); Sven KIONTKE, Jena (DE); Anna MOEHL, Jena (DE)

(73) Assignee: asphericon GmbH, Jena (DE)

(21) Appl. No.: 16/017,224

(22) Filed: Jun. 25, 2018

(30) Foreign Application Priority Data
Jun. 23, 2017 (DE) 10 2017 113 947.8

(51) Int. Cl. G02B 27/09; G02B 27/30

(52) U.S. Cl. CPC G02B 27/0927; G02B 27/30

(57) ABSTRACT

A modular system having at least one top-hat beam shaper and at least one beam expander for diffraction-limited changing of the diameter of a beam bundle, collimated to the optical axis, of monochromatic light with the same wavelength. The at least one top-hat beam shaper is set up for transforming light, collimated to the optical axis, with a wavelength and an input beam density distribution having a Gaussian profile into light, collimated to the optical axis, of an output beam density distribution with a top-hat profile with a plateau homogeneity of at most 0.133 and an edge steepness of at least 0.4. The optical components are mounted in a housing, which has a first and second fine thread formed such that they can be screwed together, wherein during the screwing together the optical axes of screwed-together optical components are aligned within the diffraction-limited divergence.

This nonprovisional application claims priority under 35 U.S.C. § 119(a) to German Patent Application No. 10 2017 113 947.8, which was filed in Germany on Jun. 23, 2017, and which is herein incorporated by reference.

### BACKGROUND OF THE INVENTION

### Field of the Invention

The present invention relates to an optical modular system for producing collimated output beams whose beam density is distributed rotationally symmetrically about the optical axis, wherein the beam density is constant in a circular inner region and the beam density is zero in an outer region surrounding the circular inner region. A beam density distribution of this kind will be referred to below as a top-hat profile.

### Description of the Background Art

Beam shapers are known from the prior art, with which bundles of collimated input beams, whose distribution in an entrance plane perpendicular to the optical axis is determined by an input beam density distribution, are transformed into bundles of collimated output beams whose distribution in an exit plane perpendicular to the optical axis is determined by an output beam density distribution. Beam shapers are also known in which the input beam density distribution is determined by a rotationally symmetrical Gaussian profile and the output beam density distribution by a top-hat profile.

Further, fiber collimators are known for collimating light that exits in a divergent manner from the exit surface of an optical fiber in a solid angle range determined by the numerical aperture of the optical fiber.

Further, beam expanders are known from the prior art with which the diameter of a collimated beam bundle can be changed.

In addition, methods and devices are known with which optical components, for example, beam shapers, fiber collimators, and/or beam expanders, can be connected to one another or fixed relative to each other and can be optically adjusted. For example, optical benches are known which comprise mounting devices for mounting optical components and fixing devices by means of which such mounting devices can be fixed relative to one another. Methods are also known with which optical components can be centered relative to each other with the aid of autocollimators and can be oriented such that the optical axes of the individual components are aligned.

It is also known from the prior art how particular optical components suitable for the transformation of a specific input beam distribution into a specific output beam distribution are designed.

### SUMMARY OF THE INVENTION

It is therefore an object of the present invention to provide an optical modular system comprising a small number of component types, which are provided standardized independent of a specific input beam distribution and a specific output beam distribution. By combining components of the same and/or different component types, optical systems can be formed with which an output beam distribution with a top-hat profile can be generated for a large number of input beam distributions. Furthermore, the invention is based on the object of providing an optical modular system of this kind, such that optical components of the same and/or different component types can be fixed more easily relative to each other and/or can be optically adjusted.

A modular system according to an exemplary embodiment comprises, as mounted optical components, at least one top-hat beam shaper, which is provided for the diffraction-limited transformation of monochromatic light, collimated to the optical axis, with a wavelength and an input beam density distribution having a Gaussian profile into light, collimated to the optical axis, with an output beam density distribution with a top-hat profile. Preferably, the top-hat beam shaper is designed as a refractive optical component. The top-hat beam shaper is designed such that the exit-side wavefront at a working distance of up to 400 mm, according to the standard DIN EN ISO 13694:2016-08 “Optics and photonics—Lasers and laser-related equipment—Test methods for laser beam power (energy) density distribution,” has a plateau homogeneity of at most 0.133 and an edge steepness of at least 0.4.

The top-hat beam shaper can be provided for a wide wavelength range from 350 nanometers to 2200 nanometers. Advantageously, such a top-hat beam shaper can be combined without adjustment with modular system optical components, which are provided for different wavelengths. Furthermore, such a modular system allows the production of top-hat beam shapers with a particularly short overall length. It is possible in addition to produce a particularly large variety of different top-hat beam shapers with a limited number of optical components.

The modular system further comprises at least one beam expander for the diffraction-limited changing of the diameter of a beam bundle, collimated to the optical axis, of monochromatic light of the same wavelength.

The mounted optical components can each be mounted in a tubular housing, arranged coaxially to the optical axis, wherein concentric to the optical axis, an annular first stop and a first fine thread are arranged at a first end of the housing and an annular second stop and a second fine thread at an opposite second end of the housing. The stops and fine threads are suitably formed and arranged such that the second fine thread of a first mounted optical component can be screwed into the first fine thread of a second optical component to a stop position in which the second stop of the housing of the first optical component contacts the first stop of the housing of the second optical component. In this stop position, the screwed-together mounted optical components are oriented such that their optical axes are aligned within the diffraction-limited divergence.

Advantageously, the inventive arrangement of optical components in housings allows the production of optical assemblies by simple screwing together. This eliminates further complicated adjustment steps, and a wide variety of optical assemblies with a high-precision, diffraction-limited optical effect can be reliably produced by combining the mounted optical components.

A further advantage of the modular system is that by screwing a top-hat beam shaper, mounted in a housing of the invention, to at least one beam expander, arranged on the exit side to the top-hat beam shaper and also mounted in a housing of the invention, the radial extent of the top-hat profile can be easily changed. For example, it is possible to increase the radial extent of the top-hat profile by a factor of 1.5 by means of a downstream beam expander. By using a threaded adapter, described in greater detail below, it is possible to arrange a beam expander on the exit side such that the radial extent of the top-hat profile is reduced by a factor of up to 6. Advantageously, it is thus possible to match the diameter of the output beam to optical elements arranged downstream in the optical path so as to improve the efficiency of lens utilization, for example, or to reduce the overall length of the entire optical system.

In addition, the top-hat beam shaper, mounted in a housing of the invention, can be screwed to at least one beam expander arranged on the entrance side. As a result, it is easily possible to match the diameter of an input beam having a Gaussian profile to the entrance-side optically effective diameter of the top-hat beam shaper.

The modular system can additionally comprise at least one fiber collimator, mounted in a collimator housing, with an entrance for feeding in monochromatic light from an optical fiber and an exit for outputting light collimated along the optical axis. The fiber collimator is provided for light of the same wavelength as the at least one top-hat beam shaper and as the at least one beam expander of the modular system.

Concentric to the optical axis at the exit of the fiber collimator, an exit-side stop and an exit-side fine thread are arranged such that the exit-side fine thread of the fiber collimator can be screwed into the first fine thread of a second optical component, mounted in a housing, to a stop position in which the exit-side stop of the fiber collimator contacts and orients the first stop of the second optical component such that the optical axes of the fiber collimator and the second component are aligned within the diffraction-limited divergence.

Advantageously, this embodiment allows the feeding of light from a laser source into an optical assembly, formed by screwed-together optical components, without further adjustment.

The fiber collimator can be made adjustable. The combination of such an adjustable fiber collimator with a mounted top-hat beam shaper and optionally with one or more mounted beam shapers is advantageous because the adjustment of an optical assembly formed therefrom is particularly easy.

A first beam expander can have a magnification of 1.5, a second beam expander a magnification of 1.75, and a third beam expander a magnification of 2.0. By screwing together such graduated beam expanders, optical assemblies for beam expansion can be produced over a wide range of overall magnifications and at fine intervals of overall magnifications without additional adjustment.

The modular system can comprises a plurality of sets of optical components, wherein a set of optical components is provided for a wavelength of the fed-in monochromatic light. As a result, the formation of optical assemblies with the retention of the diffraction-limited imaging accuracy is possible with a modular system for multiple wavelengths as well.

The modular system can additionally comprise at least one threaded adapter with a first stop and a first fine thread arranged concentrically and perpendicular to a longitudinal axis and a second stop and a second fine thread lying opposite one another along the longitudinal axis. The fine threads of the threaded adapter are formed and arranged such that they can be screwed into a fine thread of a housing of a mounted optical component to a stop position, in which a stop of the threaded adapter contacts and orients a stop of the mounted optical component such that the longitudinal axis of the threaded adapter is aligned with the optical axis of the mounted optical component within the diffraction-limited divergence of the optical component.

In an embodiment of the threaded adapter, its first and second fine threads and its first and second stops are formed and arranged to match the first fine thread and to match the first stop of a housing of the invention. By means of such an embodiment of a threaded adapter, it is possible to screw the first fine thread of a first housing via the threaded adapter into the first fine thread of a second housing. Thus, it is possible, for example, to screw the first fine thread, usually arranged on the entrance side, of a mounted flared beam expander, opposite the intended beam direction, via a threaded adapter into the first fine thread of a mounted top-hat beam shaper, such that the beam expander in this screwed-together arrangement has a beam-narrowing effect at the entrance of the top-hat beam shaper

In an embodiment of the threaded adapter, its first and second fine threads and its first and second stops are formed and arranged to match the second fine thread and to match the second stop of a housing of the invention. By means of such an embodiment of a threaded adapter, it is possible to screw the second fine thread of a first housing via the threaded adapter into the second fine thread of a second housing.

Thus, it is possible, for example, to screw the second fine thread, usually arranged on the exit side, of a mounted flared beam expander, opposite the intended beam direction, via a threaded adapter into the second fine thread of a mounted top-hat beam shaper, such that the beam expander in this screwed-together arrangement has a beam-narrowing effect at the exit of the top-hat beam shaper.

In an advantageous manner, the number of different optical systems that can be produced with a modular system can thus be greatly increased via the threaded adapter.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows the optical path through a top-hat beam shaper;

FIG. 2 schematically shows a top-hat beam shaper mounted in a housing;

FIG. 3 schematically shows the optical path in a beam expander;

FIG. 4 schematically shows a beam expander mounted in a housing;

FIG. 5 schematically shows the optical path in beam expanders arranged in a cascade;

FIG. 6 schematically shows a fiber collimator mounted in a housing,

FIG. 7 schematically shows an adjustable fiber collimator,

FIG. 8 schematically shows a threaded adapter; and

FIG. 9 schematically shows a mounted top-hat beam shaper with a screwed-on mounted beam expander.

### DETAILED DESCRIPTION

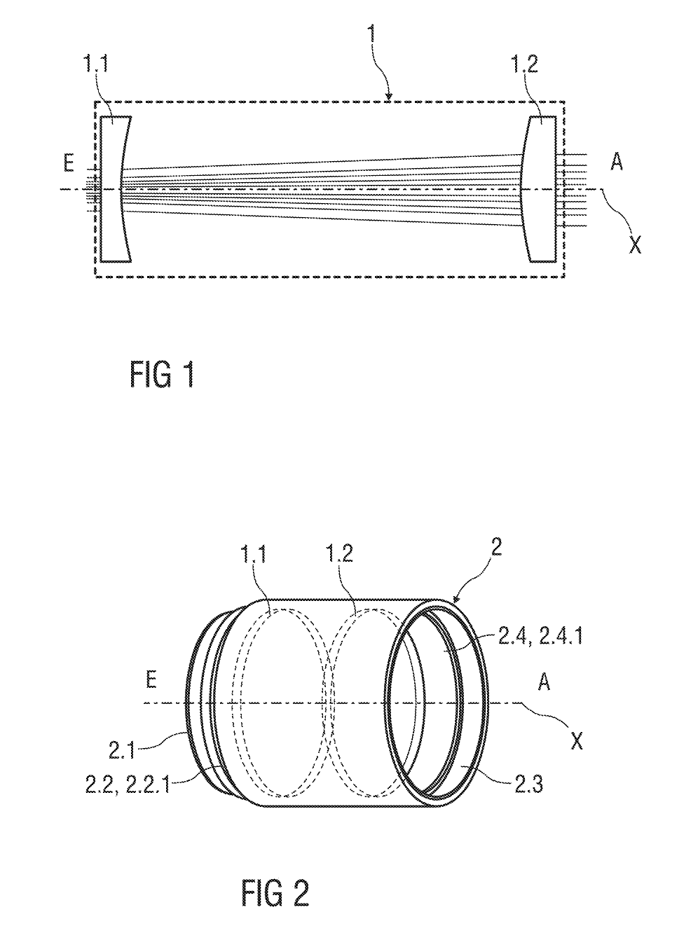

FIG. 1 schematically shows the optical path through a top-hat beam shaper 1 with an entrance E and an exit A according to the prior art. A first lens 1.1, shaped as a plano-concave lens with an aspherical concave surface, is arranged on the entrance side. A second lens 1.2, shaped as a convex-planar lens with an aspherical convex surface, is arranged on the exit side. Lenses 1.1, 1.2 are arranged concentric to optical axis X and shaped such that an input light beam ES, collimated to optical axis X, with a beam density distributed as a function of the distance to optical axis X according to a Gaussian profile, is transformed into an output beam bundle having a top-hat profile. Top-hat beam shapers 1 for transforming a Gaussian profile into a top-hat profile with a plateau homogeneity of at most 0.133 and an edge steepness of at least 0.4 are known from the prior art.

FIG. 2 schematically shows the arrangement of a top-hat beam shaper 1 which is mounted in a tubular housing 2 for receiving lenses 1.1, 1.2.

Housing 2 has an entrance-side first fine thread 2.1, an annular entrance-side first stop 2.2, an exit-side second fine thread 2.3, and an annular exit-side second stop 2.4. The entrance-side first fine thread 2.1 is formed as an outer thread at whose end facing entrance E, entrance-side first stop 2.2 is arranged. The exit-side second fine thread 2.3 is formed as an inner thread at whose end facing entrance E, the exit-side second stop 2.4 is formed as a radial projection in the inner surface of housing 2.

Fine threads 2.1, 2.3, stops 2.2, 2.4, and housing 2 are arranged coaxially to optical axis X. Stops 2.2, 2.4 each have annular stop surfaces 2.2.1, 2.4.1, which are arranged perpendicular to optical axis X. Fine threads 2.1, 2.3 and stops 2.2, 2.4 are correspondingly formed and arranged such that a first and second housing 2 can be screwed together in that first fine thread 2.1 of first housing 2 can be screwed into second fine thread 2.3 of second housing 2 or second fine thread 2.3 of first housing 2 can be screwed into first fine thread 2.1 of second housing 2.

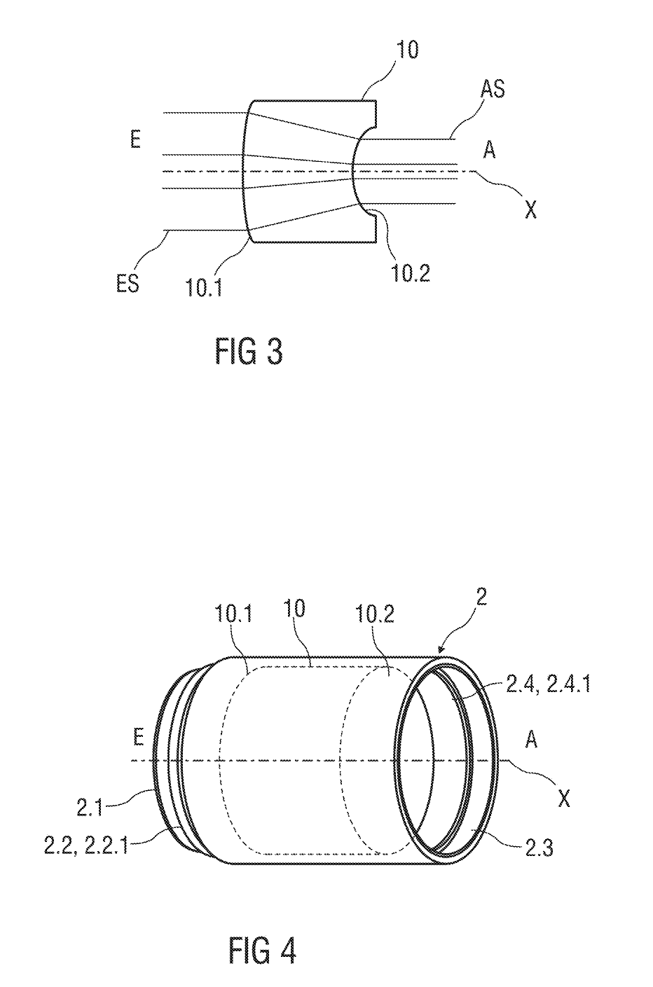

FIG. 3 schematically shows the optical path in a beam expander 10, which is made as a one-piece optical element with an entrance-side first optical surface 10.1 and an exit-side second optical surface 10.2. Beam expander 10 causes an input beam bundle ES to be transformed into an output beam bundle AS. Output beam bundle AS has a diameter that is changed compared with input beam bundle ES but has the same beam density distribution scaled to this changed diameter. Diffraction-limited beam expanders 10, in which optical surfaces 10.1, 10.2 are made as aspherical surfaces, are known from the prior art.

FIG. 4 schematically shows the arrangement of a mounted beam expander in a tubular housing 2 for receiving the one-piece optical element with optical surfaces 10.1, 10.2.

Housing 2 is similar to the housing described in FIG. 2. In particular, it has similarly formed and arranged fine threads 2.1, 2.3 and stops 2.2, 2.4.

Thus, mounted top-hat beam shapers 1 and mounted beam expanders 10, each arranged in housings 2, can be screwed together, wherein exit-side second fine thread 2.3 of top-hat beam shaper 1 can be screwed into entrance-side first fine thread 2.1 of beam expander 10.

In this case, two housings 2 can be screwed in so far until stop surfaces 2.2.1, 2.4.1 of stops 2.2, 2.4 are pressed against each other in a stop position. Fine threads 2.1, 2.3 and stop surfaces 2.2.1, 2.4.1 are made so precisely and optical elements 1.1, 1.2, 10.1, 10.2 are arranged so accurately in housings 2 that the optical axes X of a mounted top-hat beam shaper 1, arranged in a housing 2, and a mounted beam expander 10 align within the tolerance determined by the diffraction limit. In other words: when a top-hat beam shaper 1, mounted in a housing 2, and a beam expander 10 are screwed in to the stop position, an optical assembly results in which the accuracy of the optical function is limited by diffraction.

The inventive design of housing 2 makes it possible to screw together a mounted top-hat beam shaper 1 and one or two mounted beam expanders 10, such that such a top-hat beam shaper 1 can be flexibly used in various optical structures by changing the beam diameter on the entrance side and/or exit side. It is an advantage of the invention in particular that in this case no further adjustment of top-hat beam shaper 1 relative to the at least one beam expander 10 is necessary.

Beam expander 10, as shown in FIG. 5, can also be arranged in a cascade to achieve a greater change in the beam diameter. Advantageously, beam expanders 10, mounted in housings 2, can be screwed in for this purpose without further adjustment. In an embodiment of the invention, fine threads 2.1, 2.3 and stop surfaces 2.2.1, 2.4.1 are made so precisely and optical elements 1.1, 1.2, 10.1, 10.2 are arranged in housings 2 so accurately that optical axes X of a predetermined number of cascaded mounted beam expanders 10 align within the tolerance determined by the diffraction limit. In other words: when a predetermined number of beam expanders 10 mounted in a respective housing 2 are screwed in, an optical assembly is created with a magnification that results as a product of the magnifications of the individual screwed-in beam expanders 10 and at which the accuracy of the optical function is limited by diffraction. In an advantageous manner, it is thus possible, with a limited number of individual mounted beam expanders 10, by screwing in to produce beam expanders as optical assemblies, the magnification of which can be selected over a large range in a very fine graduation.

In an embodiment of the invention, beam expanders 10 have a magnification of 2.0, 1.75, or 1.5, and are screwed in such that beam expander 10 with the greatest magnification is placed at the position with the smallest beam diameter.

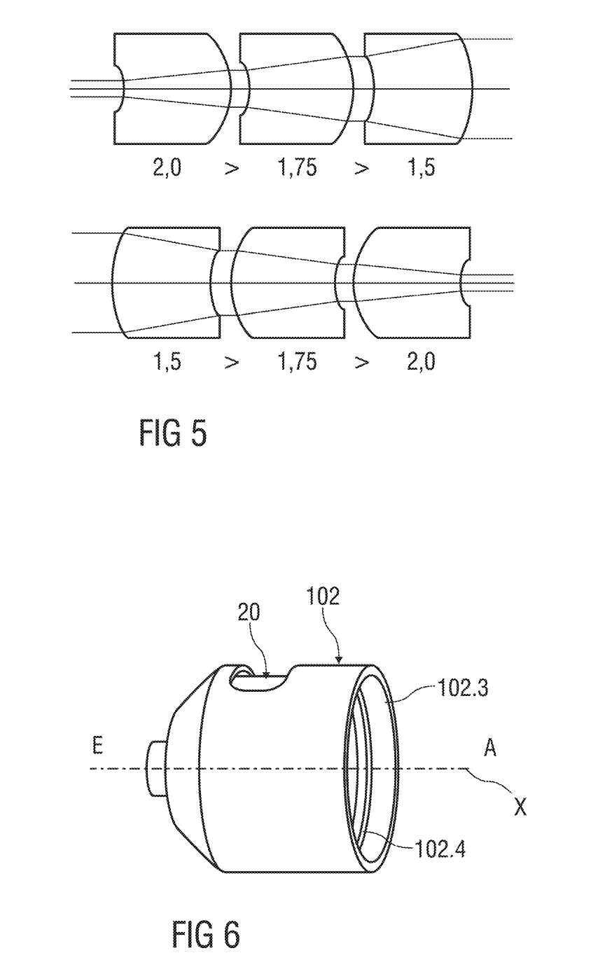

FIG. 6 shows, as a further optical component, schematically a fiber collimator 20, mounted in a housing 102, with an entrance-side fiber receptacle 20.4 for receiving an optical fiber. Fiber collimator 20 causes light emerging from the optical fiber to be collimated into an output beam bundle AS collimated to optical axis X. Fiber collimators 20 with optical elements that are formed at least partially aspherical and produce diffraction-limited collimated output beam bundles AS are known from the prior art.

According to the invention, fiber collimator 20 is provided with a collimator housing 102 which has an exit-side fine thread 102.3 and an exit-side stop 102.4, which are formed and arranged to match an entrance-side first fine thread 2.1 and an entrance-side first stop 2.2 of housing 2 described in FIG. 2. Thus, fiber collimator 20 can also be screwed without adjustment to a mounted top-hat beam shaper 1. Optionally, one or more mounted beam expanders 10 can be screwed in between mounted fiber collimator 20 and mounted top-hat beam shaper 1.

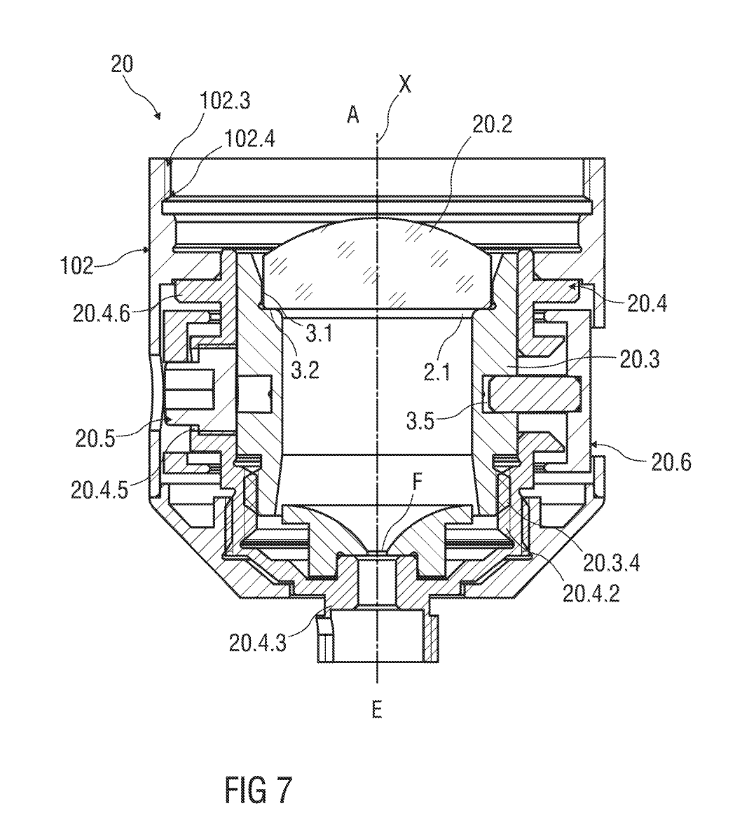

In an exemplary embodiment, fiber collimator 20 is designed as an adjustable fiber collimator, which is described in greater detail in the German patent application DE 10 2017 205 590.1 and is shown in FIG. 7, and which is incorporated herein by reference. The adjustable fiber collimator 20 has an entrance E for feeding in light from an optical fiber and an exit A for outputting light collimated along optical axis X. Such an adjustable fiber collimator comprises a collimator housing 102 in which a converging lens 20.2 is mounted whose focal point F on the entrance side lies on optical axis X. Collimator housing 102 has an exit-side fine thread 102.3 and an exit-side stop 102.4.

Adjustable fiber collimator 20 further comprises a mount 20.3, with a fine thread 20.3.4, and a tubular fiber receptacle 20.4, concentrically receiving mount 20.3, with a fiber coupling 20.4.3 for receiving the optical fiber, with a radially outwardly projecting retaining stop 20.4.6, with an eccentric receptacle 20.4.5 for rotatably receiving an eccentric fixing screw 20.5 in the sleeve jacket and with a fine thread 20.4.2, which is arranged on the inside of the sleeve jacket, is guided in fine thread 20.3.4 of mount 20.3, and converts a rotational movement about the optical axis into a longitudinal displacement of fiber receptacle 20.4 along the optical axis relative to mount 20.3.

An adjustable fiber collimator 20 further comprises an adjusting shell 20.6 annularly surrounding fiber receptacle 20.4 and rotatable thereto and non-rotatable relative to mount 20.3. Adjusting shell 20.6 comprises a fixation half-shell 20.6.2, which is longitudinally movable against mount 20.3 and which has a fixing slot 20.6.2.2, recessed along the circumference, for receiving screw head 20.5.2 of fixing screw 20.5. Adjusting shell 20.6 is pressed by means of fixing screw 20.5 into a fixing position by static friction against retaining stop 20.4.6 and released by it into a release position.

The combination of such an adjustable fiber collimator 20 with a mounted top-hat beam shaper 1 and optionally with one or more mounted beam shapers 10 is advantageous because the adjustment of an optical assembly formed therefrom is particularly easy.

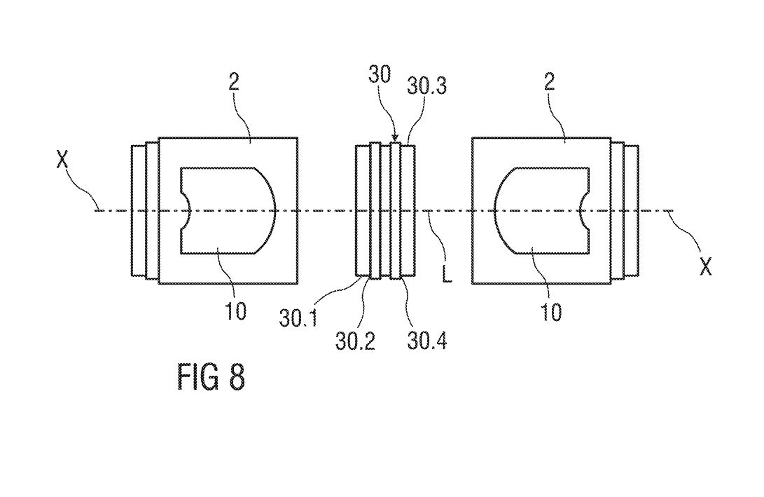

FIG. 8 shows a threaded adapter 30 for the transition from an inner thread to an outer thread. Threaded adapter 30 is formed tubular extending along a longitudinal axis L and has at one end first fine thread 30.1, formed as an outer thread, and a first stop 30.2. At the opposite end, threaded adapter 30 has a second fine thread 30.3, likewise formed as an outer thread, and a second stop 30.4. Fine threads 30.1, 30.3 and stops 30.2, 30.4 are formed and arranged to match second thread 2.3, 102.3, formed as an inner thread, and second stop 2.4, 102.4 of a housing 2, 102, such that in each case a fine thread 30.1, 30.3 of threaded adapter 30 can be screwed into second fine thread 2.3, 102.3 of a first housing 2, 102 and a second housing 2 to a stop position. In this stop position, the longitudinal axis L of threaded adapter 30 is aligned with optical axes X of the optical components which are mounted in first and second housing 2 and which are made by way of example as beam expander 10.

In an analogous manner, fine thread 30.1, 30.3 can be made as an inner thread matching first thread 2.1, formed as an outer thread, and stops 30.2, 30.4 corresponding to the first stop of a housing 2.

Threaded adapter 30 expands the number of optical assemblies that can be produced with the modular system by virtue of the fact that the beam direction of an optical component can be reversed by screwing together threaded adapter 30 and an optical component mounted in a housing 2.

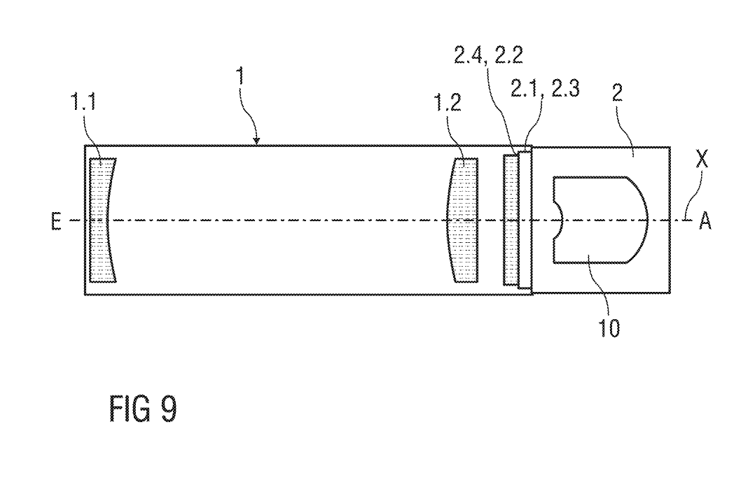

FIG. 9 shows a top-hat beam shaper 1 with a beam expander 10 screwed in on the exit side, wherein first fine thread 2.1 of mounted beam expander 10 is screwed into second fine thread 2.3 of mounted top-hat beam shaper 1. First stop 2.2, arranged on the entrance side, of beam expander 10 contacts the second stop 2.4, arranged on the exit side, of the mounted top-hat beam shaper. As a result, optical axes X of beam expander 10 and top-hat beam shaper 1 are oriented aligned within the diffraction-limited divergence.

An advantage of the modular system of the invention is that a large variety of assemblies with different optical effects can be produced with a limited number of optical components 1, 10, wherein the diffraction-limited high optical quality of the individual optical components 1, 10 is maintained. For example, in an embodiment of the invention, it is possible to screw on further beam expanders 10 on the exit side or to reverse the beam direction within a beam expander 10 by using a threaded adapter 30 as described, and thus to reduce the radial extent of a top-hat profile.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A modular system comprising as optical components:
at least one top-hat beam shaper for transforming light, collimated to an optical axis, with a wavelength and an input beam density distribution having a Gaussian profile into light, collimated to the optical axis of an output beam density distribution with a top-hat profile with a plateau homogeneity of at most 0.133 and an edge steepness of at least 0.4; and
at least one beam expander for diffraction-limited changing of a diameter of a beam bundle collimated to the optical axis of monochromatic light with the same wavelength,
wherein the top-hat beam shaper and beam expander are mounted in a tubular housing arranged coaxially to the optical axis, and
wherein concentric to the optical axis, an annular first stop and a first fine thread are arranged at a first end of the housing and an annular second stop and a second fine thread are formed and arranged at a second end of the housing such that the second fine thread of a first mounted optical component is adapted to be screwed into the first fine thread of a second optical component to a stop position in which the second stop of the housing of the first optical component contacts and orients the first stop of the housing of the second optical component such that the optical axes of the first and second optical components are aligned within the diffraction-limited divergence.

2. The modular system according to claim 1, further comprising at least two beam expanders set up for a cascaded arrangement.

3. The modular system according to claim 1, further comprising at least one fiber collimator mounted in a collimator housing, with an entrance for feeding in monochromatic light of the same wavelength from an optical fiber and an exit for outputting light collimated along the optical axis, wherein concentric to the optical axis at the exit of the fiber collimator, an exit-side stop and an exit-side fine thread are arranged such that the exit-side fine thread of the fiber collimator is adapted to be screwed into the first fine thread of a second optical component mounted in a housing to a stop position in which the exit-side stop of the fiber collimator contacts and orients the first stop of the second optical component such that the optical axes of the fiber collimator and the second component are aligned within the diffraction-limited divergence.

4. The modular system according to claim 1, wherein a first beam expander has a magnification of 1.5, a second beam expander a magnification of 1.75, and a third beam expander a magnification of 2.0.

5. The modular system according to claim 1, further comprising a plurality of sets of optical components, and wherein a set of optical components is provided for a wavelength of the fed-in monochromatic light.

6. The modular system according to claim 1, further comprising at least one threaded adapter with a first stop arranged concentrically and substantially perpendicular to a longitudinal axis, and a first fine thread and a second stop, opposite along the longitudinal axis, and a second fine thread, wherein the fine threads of the threaded adapter are adapted to be screwed into a fine thread of a housing of a mounted optical component to a stop position, in which a stop of the threaded adapter contacts and orients a stop of the mounted optical component such that the longitudinal axis of the threaded adapter is aligned with the optical axis of the mounted optical component within the diffraction-limited divergence of the optical component.
